(19) United States
(12) Patent Application Publication
(10) Pub. No.: US 2019/0391940 A1
(43) Pub. Date: Dec. 26, 2019

(54) TECHNOLOGIES FOR INTERRUPT DISASSOCIATED QUEUING FOR MULTI-QUEUE I/O DEVICES

(71) Applicant: Intel Corporation, Santa Clara, CA (US)

(72) Inventors: Anil Vasudevan, Portland, OR (US); Sridhar Samudrala, Beaverton, OR (US); Parthasarathy Sarangam, Portland, OR (US); Kiran Patil, Portland, OR (US)

(21) Appl. No.: 16/457,110

(22) Filed: Jun. 28, 2019

(51) Int. Cl. G06F 13/24; G06F 9/48; G06F 9/4401; G06F 3/06

(52) U.S. Cl. CPC G06F 13/24; G06F 9/4812; G06F 9/4418; G06F 3/0674; G06F 3/0611; G06F 3/0653; G06F 3/0613

(57) ABSTRACT

Technologies for interrupt disassociated queuing for multi-queue input/output devices includes determining whether a network packet has arrived in an interrupt-disassociated queue and delivering the network packet to an application managed by the compute node. The application is associated with an application thread and the interrupt-disassociated queue may be in a polling mode. Subsequently, in response to a transition event, the interrupt-disassociated queue may be transitioned to an interrupt mode.

### BACKGROUND

Modern computing devices have become ubiquitous tools for personal, business, and social uses. Such computing devices typically include various compute (e.g., one or more processors with one or more processor cores) and storage resources (e.g., cache memory, main memory, etc.), as well as multiple input/output (I/O) devices. Multi-queue I/O devices, such as a network interface controller (NIC), traditionally tie an interrupt to a queue for signaling events on the associated queue. Some solutions can associate multiple queues to a single interrupt and trigger an I/O processing operation (e.g., a protocol-based processing operation) on each of the queues by a processor core on which the interrupt has been fired.

When an interrupt associated with a queue, or multiple queues, fires, an interrupt service routine (ISR), such as I/O processing, is typically initiated in the context of the interrupt (e.g. through a software interrupt context) on the processor core on which the software interrupt contexts are scheduled, which is typically the processor core on which the interrupt has been fired. However, performing I/O processing on the processor core on which the interrupt has been fired, in particular with multiple queues, generally does not allow optimal processor core scaling of I/O processing. Additionally, in the case of a single interrupt-single queue configuration, the number of interrupt vector resources being consumed for the many thousands of queues on a computing device does not typically scale. Further, there is oftentimes not an option for triggering all I/O processing from the application, which could otherwise improve processing performance levels.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a system for interrupt disassociated queuing for multi-queue input/output (I/O) devices;

FIG. 2 is a simplified block diagram of at least one embodiment of a compute node of the system of FIG. 1;

FIG. 3 is a simplified block diagram of at least one embodiment of an environment that may be established by the compute node of FIGS. 1 and 2;

FIG. 4 is a simplified block diagram of at least one embodiment of an illustrative set of fields of interest of a deferred call context;

FIGS. 5 and 6 is a simplified flow diagram of at least one embodiment of a method for managing interrupt disassociated queues for multi-queue I/O devices that may be executed by the compute nodes of FIGS. 1-3;

FIG. 7 is a simplified flow diagram of at least one embodiment of a method for managing data packets that may be executed by the compute nodes of FIGS. 1-3;

FIG. 8 is a simplified state flow diagram of at least one embodiment for illustrating state transitions for interrupt disassociated queues for multi-queue I/O devices of the compute nodes of FIGS. 1-3; and

FIG. 9 is a simplified block diagram of at least one embodiment of an illustrative wakeup list and an illustrative interrupt event queue associated with the wakeup list.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one of A, B, and C” can mean (A); (B); (C): (A and B); (A and C); (B and C); or (A, B, and C). Similarly, items listed in the form of “at least one of A, B, or C” can mean (A); (B); (C): (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on one or more transitory or non-transitory machine-readable (e.g., computer-readable) storage media, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

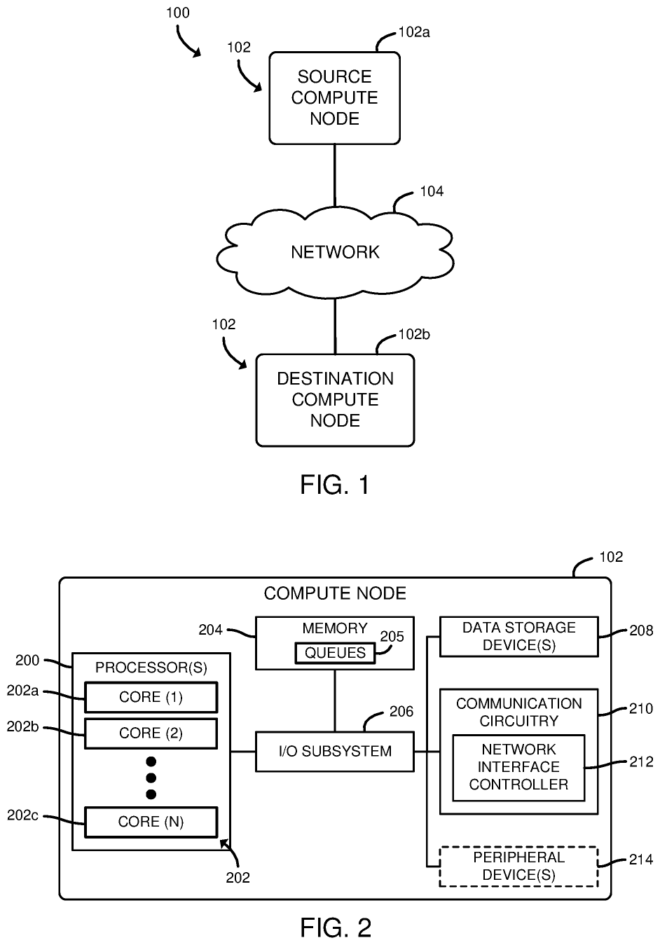

Referring now to FIG. 1, in an illustrative embodiment, a system 100 for interrupt disassociated queuing for multi-queue input/output (I/O) devices includes a source compute node 102a communicatively coupled to a destination compute node 102b via a network 104. While illustratively shown as having two compute nodes 102, the system 100 may include multiple compute nodes 102 in other embodiments. It should be appreciated that the source compute node 102a and the destination compute node 102b have been illustratively designated and described herein, as being one of a “source” of network traffic (i.e., the source compute node 102a) and a “destination” of the network traffic (i.e., the destination compute node 102b) for the purposes of providing clarity to the description. It should be further appreciated that, in some embodiments, the source compute node 102a and the destination compute node 102b may reside in the same data center or high-performance computing (HPC) environment. In other words, the source compute node 102a and the destination compute node 102b may reside in the same network 104 connected via one or more wired and/or wireless interconnects.

In an illustrative example, the source compute node 102a generates a network packet that includes data to be transmitted to and processed by the destination compute node 102b. The destination compute node 102b, or more particularly a network interface controller (NIC) (see, e.g., the NIC 212 of FIG. 2) of the destination compute node 102b, receives the network packet, and the destination compute node 102b identifies how to process the network packet, such as by performing one or more processing operations on at least a portion of the data of the received network packet. Such processing is typically performed by a processor (see, e.g., the processor(s) 200 of FIG. 2), or more particularly a core of a processor (see, e.g., one of the processor cores 202 of FIG. 2), of the destination compute node 102b.

To initiate such processing, the NIC is configured to register an event, or interrupt, which is then received or retrieved by the applicable processor. It should be appreciated that, as I/O devices such as the NIC have become faster, polling has become an acceptable and common method for event waiting, especially as the wait times reduce due to faster I/O. It should be further appreciated that it takes lower overhead and latency to busy wait on the I/O device for notification versus switching out tasks, taking an interrupt for notification, and waking up the task and scheduling it to run again, as is done is traditional interrupt flows.

However, unlike traditional techniques, the NIC as described herein is configured to scale down the number of interrupt vectors used by the NIC, or any other I/O device, by sharing interrupts dynamically across multiple queues. Further, the NIC is additionally configured to use the interrupt signaling to initiate application triggered I/O processing in the context of the application, rather than initiate I/O processing on behalf of the application in its context. Accordingly, the choice of having all I/O processing always be application triggered allows the queues across multiple applications to scale, reducing the number of interrupts on a system and the movement of data within the given platform.

To do so, the NIC, or more particularly a device driver of the NIC, is configured to instantiate an interrupt disassociated deferred call routine (i.e., a deferred call routine that is not associated with an interrupt). In a traditional interrupt flow, when an interrupt fires, a deferred call is scheduled. It should be appreciated that each hardware interrupt has an associated context, or interface, to use interrupt mitigation techniques for I/O devices (e.g., a new application programming in NAPI-context in Linux-based operating systems for networking devices). This context associated with each hardware interrupt serves as an input into a deferred call routine, where network packet descriptor and data processing occurs. The hardware interrupt context (e.g., a generic representation of the associated context provided to a deferred call across various operating systems) stores relevant information about its associated event (e.g., the interrupt).

As described previously, polling has become an acceptable and common method for event waiting. For example, in some embodiments, an application may employ a busy polling technique, which is application triggered (i.e., versus being interrupt triggered). As described herein, busy polling can use the same deferred call routine as the interrupt disassociated deferred call. Accordingly, two sources drive the execution of the deferred routine: the hardware interrupt and a thread associated with an application (i.e., an application thread). It should be appreciated that, since the origins of the hardware interrupt context are based on a hardware interrupt source, there is enough state embedded in it for that source.

Additionally, as described herein, the hardware interrupt context has been enhanced to include additional state for those instances in which an application thread is the source. In particular, just like interrupt vector information is embedded with a hardware interrupt context for the hardware interrupt usage employed in existing techniques, calling application thread information can be embedded for those instances in which the deferred call routine is invoked from an application, referred to herein as an interrupt disassociated deferred call routine. It should be appreciated that while the functionality described herein is primarily directed toward a NIC, such functionality may be performed relative to any multi-queue I/O device.

The compute nodes 102 may be embodied as any type of computation or computer device capable of performing the functions described herein, including, without limitation, a computer, a server (e.g., stand-alone, rack-mounted, blade, etc.), a sled (e.g., a compute sled, an accelerator sled, a storage sled, a memory sled, etc.), an enhanced or smart NIC/HFI, a network appliance (e.g., physical or virtual), a router, switch (e.g., a disaggregated switch, a rack-mounted switch, a standalone switch, a fully managed switch, a partially managed switch, a full-duplex switch, and/or a half-duplex communication mode enabled switch), a web appliance, a distributed computing system, a processor-based system, and/or a multiprocessor system.

As shown in FIG. 2, an illustrative compute node 102 (e.g., an illustrative one of the source compute node 102a, the destination compute node 102b, etc.) is shown that includes one or more processors 200, memory 204, an I/O subsystem 206, one or more data storage devices 208, communication circuitry 210, and, in some embodiments, one or more peripheral devices 214. It should be appreciated that the compute node 102 may include other or additional components, such as those commonly found in a typical computing device (e.g., various input/output devices and/or other components), in other embodiments. Additionally, in some embodiments, one or more of the illustrative components may be incorporated in, or otherwise form a portion of, another component.

The processor(s) 200 may be embodied as any type of device or collection of devices capable of performing the various compute functions as described herein. In some embodiments, the processor(s) 200 may be embodied as one or more multi-core processors, digital signal processors (DSPs), microcontrollers, or other processor(s) or processing/controlling circuit(s). In some embodiments, the processor(s) 200 may be embodied as, include, or otherwise be coupled to an integrated circuit, an embedded system, a field-programmable-array (FPGA), a system-on-a-chip (SOC), an application specific integrated circuit (ASIC), reconfigurable hardware or hardware circuitry, or other specialized hardware to facilitate performance of the functions described herein.

The illustrative processor(s) 200 includes multiple processor cores 202 (e.g., two processor cores, four processor cores, eight processor cores, sixteen processor cores, etc.). The illustrative processor cores include a first processor core 202 designated as core (1) 202a, a second processor core 202 designated as core (2) 202b, and a third processor core 202 designated as core (N) 202c (e.g., wherein the core (N) 202c is the “Nth” processor core 202 and “N” is a positive integer). Each of processor cores 202 may be embodied as an independent logical execution unit capable of executing programmed instructions. It should be appreciated that, in some embodiments, the compute node 102 (e.g., in supercomputer embodiments) may include thousands of processor cores 202. Each of the processor(s) 200 may be connected to a physical connector, or socket, on a motherboard (not shown) of the compute node 102 that is configured to accept a single physical processor package (i.e., a multi-core physical integrated circuit). It should be appreciated that, while not illustratively shown, each of the processor cores 202 may be communicatively coupled to at least a portion of a cache memory and functional units usable to independently execute programs, operations, threads, etc.

The memory 204 may be embodied as any type of volatile or non-volatile memory or data storage capable of performing the functions described herein. In operation, the memory 204 may store various data and software used during operation of the compute node 102, such as operating systems, applications, programs, libraries, and drivers. It should be appreciated that the memory 204 may be referred to as main memory, or a primary memory. It should be understood that volatile memory may be a storage medium that requires power to maintain the state of data stored by the medium. Non-limiting examples of volatile memory may include various types of random access memory (RAM), such as dynamic random access memory (DRAM) or static random access memory (SRAM).

One particular type of DRAM that may be used in a memory module is synchronous dynamic random access memory (SDRAM). In particular embodiments, DRAM of a memory component may comply with a standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4 (these standards are available at www.jedec.org). Such standards (and similar standards) may be referred to as DDR-based standards and communication interfaces of the storage devices that implement such standards may be referred to as DDR-based interfaces.

In one embodiment, the memory 204 is a block addressable memory device, such as those based on NAND or NOR technologies. A memory device may also include a three dimensional crosspoint memory device (e.g., Intel 3D XPoint™ memory), or other byte addressable write-in-place nonvolatile memory devices. In one embodiment, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory. The memory device may refer to the die itself and/or to a packaged memory product.

In some embodiments, 3D crosspoint memory (e.g., Intel 3D XPoint™ memory) may comprise a transistor-less stackable cross point architecture in which memory cells sit at the intersection of word lines and bit lines and are individually addressable and in which bit storage is based on a change in bulk resistance. In some embodiments, all or a portion of the memory 204 may be integrated into the processor 200. In operation, the memory 204 may store various software and data used during operation such as workload data, hardware queue manager data, migration condition data, applications, programs, libraries, and drivers. In the illustrative embodiment, a number of queues 205 are defined in the memory 204 to store packet data received by the communication circuitry 210 (i.e., by the network interface controller 212 described below).

Each of the processor(s) 200 and the memory 204 are communicatively coupled to other components of the compute node 102 via the I/O subsystem 206, which may be embodied as circuitry and/or components to facilitate input/output operations with the processor(s) 200, the memory 204, and other components of the compute node 102. For example, the I/O subsystem 206 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some embodiments, the I/O subsystem 206 may form a portion of a SoC and be incorporated, along with one or more of the processors 200, the memory 204, and other components of the compute node 102, on a single integrated circuit chip.

The one or more data storage devices 208 may be embodied as any type of storage device(s) configured for short-term or long-term storage of data, such as, for example, memory devices and circuits, memory cards, hard disk drives, solid-state drives, or other data storage devices. Each data storage device 208 may include a system partition that stores data and firmware code for the data storage device 208. Each data storage device 208 may also include an operating system partition that stores data files and executables for an operating system.

The communication circuitry 210 may be embodied as any communication circuit, device, or collection thereof, capable of enabling communications between the compute node 102 and other computing devices, as well as any network communication enabling devices, such as an access point, switch, router, etc., to allow communication over the network 104. Accordingly, the communication circuitry 210 may be configured to use any one or more communication technologies (e.g., wireless or wired communication technologies) and associated protocols (e.g., Ethernet, Bluetooth®, Wi-Fi®, WiMAX, LTE, 5G, etc.) to effect such communication. It should be appreciated that, in some embodiments, the communication circuitry 210 may include specialized circuitry, hardware, or combination thereof to perform pipeline logic (e.g., hardware algorithms) for performing the functions described herein, including processing network packets (e.g., parse received network packets, determine target compute nodes for each received network packets, forward the network packets to a particular buffer queue of a respective host buffer of the compute node 102, etc.), performing computational functions, storing data, etc.

In some embodiments, performance of one or more of the functions of communication circuitry 210 as described herein may be performed by specialized circuitry, hardware, or combination thereof of the communication circuitry 210, which may be embodied as a SoC or otherwise form a portion of a SoC of the compute node 102 (e.g., incorporated on a single integrated circuit chip along with one of the processor(s) 200, the memory 204, and/or other components of the compute node 102). Alternatively, in some embodiments, the specialized circuitry, hardware, or combination thereof may be embodied as one or more discrete processing units of the compute node 102, each of which may be capable of performing one or more of the functions described herein.

The illustrative communication circuitry 210 includes the NIC 212, which may be embodied as one or more add-in-boards, daughtercards, network interface cards, controller chips, chipsets, or other devices that may be used by the compute node 102 to connect with another compute device (e.g., another compute node 102). In some embodiments, the NIC 212 may be embodied as part of a SoC that includes one or more processors, or included on a multichip package that also contains one or more processors. While not illustratively shown, it should be understood that the NIC 212 includes one or more physical ports for facilitating the ingress and egress of network traffic to/from the NIC 212. Additionally, in some embodiments, the NIC 212 may include one or more offloads/accelerators, such as a direct memory access (DMA) engine. Additionally or alternatively, in some embodiments, the NIC 212 may include a local processor (not shown) and/or a local memory (not shown) that are both local to the NIC 212. In such embodiments, the local processor of the NIC 212 may be capable of performing one or more of the functions of a processor 200 described herein. Additionally or alternatively, in such embodiments, the local memory of the NIC 212 may be integrated into one or more components of the compute node 102 at the board level, socket level, chip level, and/or other levels.

The one or more peripheral devices 214 may include any type of device that is usable to input information into the compute node 102 and/or receive information from the compute node 102. The peripheral devices 214 may be embodied as any auxiliary device usable to input information into the compute node 102, such as a keyboard, a mouse, a microphone, a barcode reader, an image scanner, etc., or output information from the compute node 102, such as a display, a speaker, graphics circuitry, a printer, a projector, etc. It should be appreciated that, in some embodiments, one or more of the peripheral devices 214 may function as both an input device and an output device (e.g., a touchscreen display, a digitizer on top of a display screen, etc.). It should be further appreciated that the types of peripheral devices 214 connected to the compute node 102 may depend on, for example, the type and/or intended use of the compute node 102. Additionally or alternatively, in some embodiments, the peripheral devices 214 may include one or more ports, such as a USB port, for example, for connecting external peripheral devices to the compute node 102. In some embodiments, the one or more peripheral devices 214 may include one or more sensors (e.g., a temperature sensor, a fan sensor, etc.).

Referring back to FIG. 1, the network 104 may be embodied as any type of wired or wireless communication network, including but not limited to a wireless local area network (WLAN), a wireless personal area network (WPAN), an edge network (e.g., a multi-access edge computing (MEC) network), a fog network, a cellular network (e.g., Global System for Mobile Communications (GSM), Long-Term Evolution (LTE), 5G, etc.), a telephony network, a digital subscriber line (DSL) network, a cable network, a local area network (LAN), a wide area network (WAN), a global network (e.g., the Internet), or any combination thereof. It should be appreciated that, in such embodiments, the network 104 may serve as a centralized network and, in some embodiments, may be communicatively coupled to another network (e.g., the Internet). Accordingly, the network 104 may include a variety of other virtual and/or physical network computing devices (e.g., routers, switches, network hubs, servers, storage devices, compute devices, etc.), as needed to facilitate communication between the source compute node 102a and the destination compute node 102b, which are not shown to preserve clarity of the description.

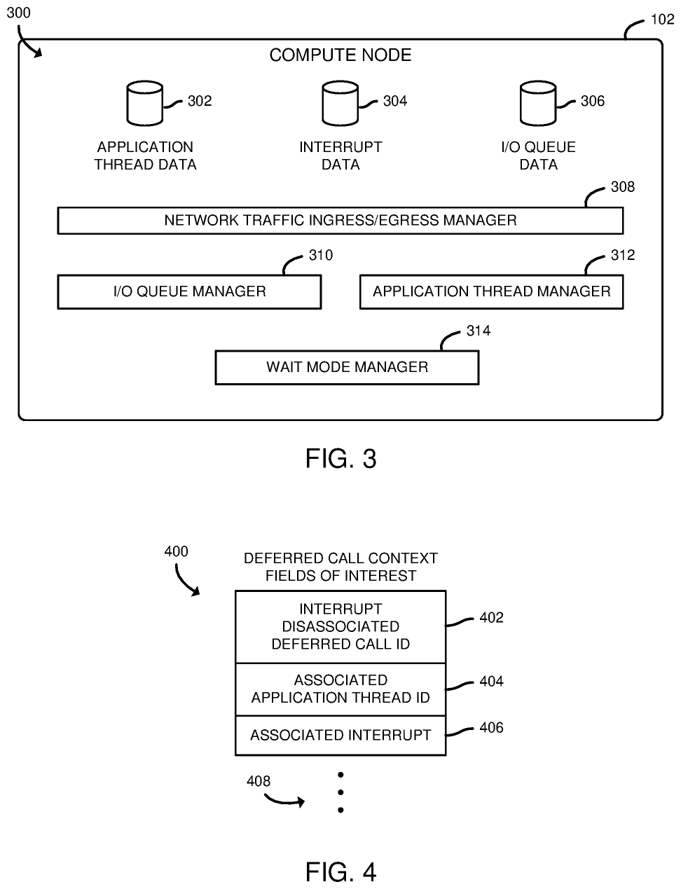

Referring now to FIG. 3, the compute node 102 may establish an environment 300 during operation. The illustrative environment 300 includes a network traffic ingress/egress manager 308, an I/O queue manager 310, an application thread manager 312, and a wait mode manager 314. The various components of the environment 300 may be embodied as hardware, firmware, software, or a combination thereof. As such, in some embodiments, one or more of the components of the environment 300 may be embodied as circuitry or a collection of electrical devices (e.g., network traffic ingress/egress management circuitry 308, I/O queue management circuitry 310, application thread management circuitry 312, wait mode management circuitry 314, etc.). It should be appreciated that, in such embodiments, one or more of the network traffic ingress/egress management circuitry 308, the I/O queue management circuitry 310, the application thread management circuitry 312, and the wait mode management circuitry 314 may form a portion of one or more of the processor(s) 200, the memory 204, the communication circuitry 210, the I/O subsystem 206 and/or other components of the compute node 102.

It should be further appreciated that, in other embodiments, one or more functions described herein as being performed by a particular component of the compute node 102 may be performed, at least in part, by one or more other components of the compute node 102, such as the one or more processors 200, the I/O subsystem 206, the communication circuitry 210, an ASIC, a programmable circuit such as an FPGA, and/or other components of the compute node 102. It should be further appreciated that associated instructions may be stored in the memory 204, the data storage device(s) 208, and/or other data storage location, which may be executed by one of the processors 200 and/or other computational processor of the compute node 102.

Additionally, in some embodiments, one or more of the illustrative components may form a portion of another component and/or one or more of the illustrative components may be independent of one another. Further, in some embodiments, one or more of the components of the environment 300 may be embodied as virtualized hardware components or emulated architecture, which may be established and maintained by the NIC 212, the processor(s) 200, or other components of the compute node 102. It should be appreciated that the compute node 102 may include other components, sub-components, modules, sub-modules, logic, sub-logic, and/or devices commonly found in a computing device, which are not illustrated in FIG. 2 for clarity of the description.

In the illustrative embodiment, the environment 300 includes application thread data 302, interrupt data 304, and I/O queue data 306, each of which may be accessed by the various components and/or sub-components of the compute node 102. Additionally, it should be appreciated that in some embodiments the data stored in, or otherwise represented by, each of the application thread data 302, the interrupt data 304, and the I/O queue data 306 may not be mutually exclusive relative to each other. For example, in some implementations, data stored in the application thread data 302 may also be stored as a portion of the interrupt data 304 and/or the I/O queue data 306. As such, although the various data utilized by the compute node 102 is described herein as particular discrete data, such data may be combined, aggregated, and/or otherwise form portions of a single or multiple data sets, including duplicative copies, in other embodiments. The I/O queue data 306 may be stored in the queues 205 of the memory 204.

The network traffic ingress/egress manager 308, which may be embodied as hardware, firmware, software, virtualized hardware, emulated architecture, and/or a combination thereof as discussed above, is configured to receive inbound and route/transmit outbound network traffic. To do so, the network traffic ingress/egress manager 308 is configured to facilitate inbound/outbound network communications (e.g., network traffic, network packets, network flows, etc.) to and from the compute node 102. For example, the network traffic ingress/egress manager 308 is configured to manage (e.g., create, modify, delete, etc.) connections to physical and virtual network ports (i.e., virtual network interfaces) of the compute node 102 (e.g., via the communication circuitry 210), as well as the ingress/egress buffers/queues associated therewith.

The I/O queue manager 310, which may be embodied as hardware, firmware, software, virtualized hardware, emulated architecture, and/or a combination thereof as discussed above, is configured to manage the queues associated with the I/O devices of the compute node 102 (e.g., the NIC 212 of FIG. 2). Additionally, the I/O queue manager 310 is configured to map the interrupts that have been shared dynamically across the multiple queues managed by the I/O queue manager 310. To do so, the I/O queue manager 310 is configured to associate an I/O device queue with a unique interrupt disassociated identifier corresponding to a context of a deferred call routine. It should be appreciated that each driver of the various I/O devices of the compute node 102 is configured to instantiate a deferred call routine that is not associated with an interrupt.

Referring now to FIG. 4, an illustrative representation of an example set of fields of interest 400 within a context of a deferred call routine is shown. As described previously, the obtained context of the deferred call routine is trigger agnostic, as the context is associated with the unique interrupt disassociated deferred call identifier. As such, software executing on the compute node 102 can associate an I/O queue, via the I/O queue manager 310, with the unique interrupt disassociated deferred call identifier. In other words, the unique interrupt disassociated deferred call identifier allows the I/O device queue to be tied to an application (e.g., using present techniques).

Accordingly, a collection of queues is created where the majority of the queues may not have an associated interrupt, which can reduce interrupt associated resources. Additionally, a separate queue-agnostic interrupt-associated call routine is also created, to which queues can be added and removed dynamically. As illustratively shown, the example set of deferred call context fields of interest 400 include an interrupt disassociated deferred call identifier field of interest 402 that ties an I/O queue to a software application, an associated application thread identifier field of interest 404 that indicates an application thread associated with the deferred call context, and an interrupt field of interest 406 that indicates the interrupt associated with the deferred call context. Of course, in some embodiments, the deferred call context fields of interest 400 may include additional fields 408 indicated in FIG. 4 by corresponding ellipses.

Referring back to FIG. 3, the application thread manager 312, which may be embodied as hardware, firmware, software, virtualized hardware, emulated architecture, and/or a combination thereof as discussed above, is configured to manage the application threads associated with software applications executing on the compute node 102. The wait mode manager 314, which may be embodied as hardware, firmware, software, virtualized hardware, emulated architecture, and/or a combination thereof as discussed above, is configured to switch the wait mode associated with a given application thread between a polling event wait mode and an interrupt event wait mode.

During steady state operations, interrupt disassociated queues can be polled by an application thread, busy polling for data. When polling stops, the interrupt disassociated queue is quiesced and its context updated with the current application thread identifier that initiated the polling. It should be appreciated that when and how polling stops, and the interrupt disassociated queue is quiesced, is application dependent. For example, the polling stop could be triggered from an application (e.g., via the application thread manager 312), inferred by the stack based on certain control traffic patterns, or as a result of a polling timeout. The quiesced interrupt disassociated queue can then be associated with an interrupt (e.g., by the I/O queue manager 310). Accordingly, a wait mode associated with the application thread is switched from being in the polling event wait mode to an interrupt event wait mode (e.g., by the wait mode manager 314). It should be appreciated that, once associated with an interrupt, any new activity on the interrupt disassociated queue can cause an interrupt to be generated.

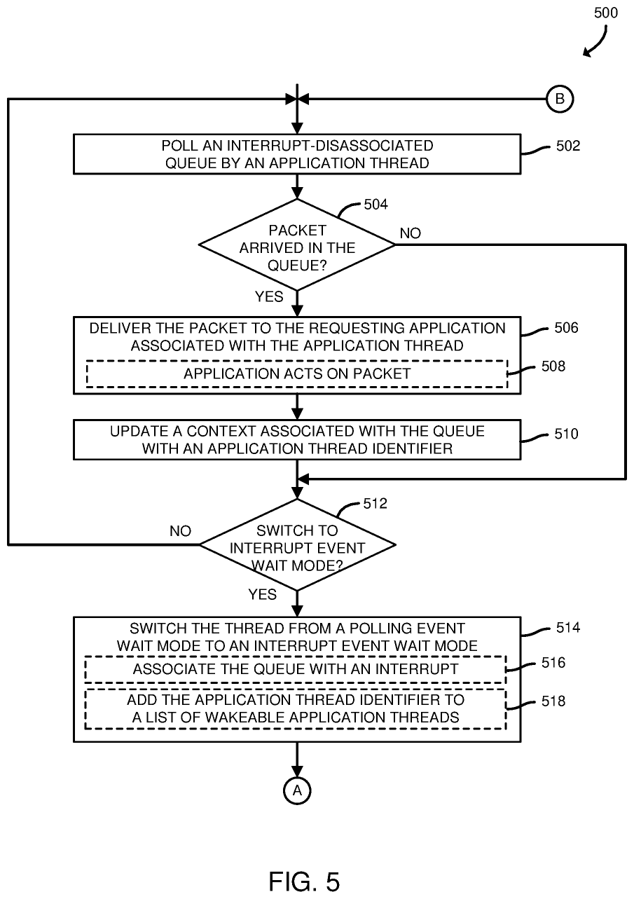

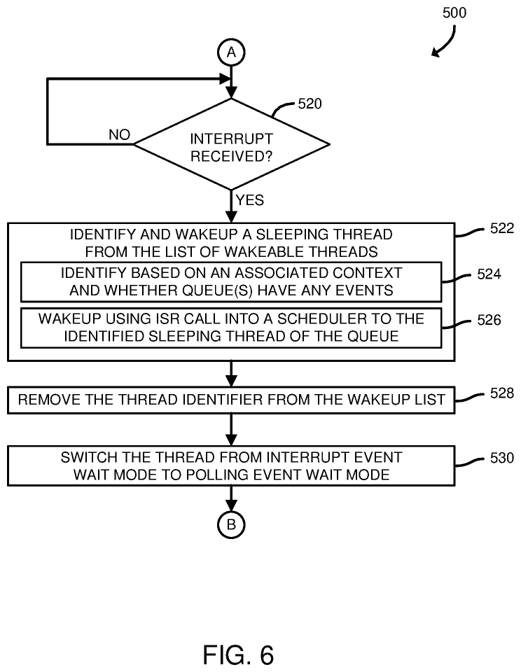

Referring now to FIGS. 5 and 6, a method 500 for managing interrupt disassociated queues for multi-queue I/O devices may be executed by a compute node (e.g., one of the compute nodes 102 of FIG. 1). The method 500 begins with block 502, in which an application presently executing on the compute node 102 (e.g. on one or more cores 202), via an application thread associated with the application, polls an interrupt disassociated queue (e.g. one or more of the queues 205). The particular queue that is polled may be based on various criteria such as security policies of the compute node. Additionally or alternatively, the queues may be assigned or dedicated to the application (e.g., each thread may be dedicated to a particular application using a 1:1 mapping scheme). Regardless, in block 504, the compute node 102 determines whether a network packet has arrived in the queue (e.g., via the NIC 212 of FIG. 2). If so, the method 500 advances to block 506; otherwise, the method 500 advances to block 512 discussed below.

In block 506, the compute node 102 retrieves the packet from the associated queue and delivers the packet to the requesting application associated with the application thread (e.g., based on the application thread identifier), and the application may act on the packet in block 508. Subsequently, in block 510, the compute node 102 updates a context associated with the interrupt disassociated queue with an identifier of the application thread (i.e., an application thread identifier).

In block 512, the compute node 102 determines whether to switch to interrupt event mode polling. The compute node 102 may determine to switch to the interrupt event mode polling in response to detection or determination of one or more transition events. For example, in some embodiments, the compute node 102 may determine to which to the interrupt event mode polling in response to a determination or detection that application is going to sleep. Additionally, in some embodiments, if the application fails to respond within an expected time period, the compute node 102 may switch to the interrupt event mode polling. In such cases, a generated interrupt may provide a hint to the corresponding operating system scheduler regarding the unresponsive application, which may cause a build-up of associated queues.

If the compute node 102 determines not to switch to the interrupt event wait mode, the method 500 loops back to block 502 in which an application presently executing on the compute node 102, via an application thread associated with the application, polls an interrupt disassociated queue. If, however, the compute node 102 determines to switch to the interrupt event wait mode, the compute node 102 switches the application thread from a polling event wait mode to an interrupt event wait mode in block 514. To do so, in block 516, the compute node 102 may associate the interrupt disassociated queue with an interrupt. Additionally, in block 518, the compute node 102 may add the application thread identifier to a list of wakeable application threads.

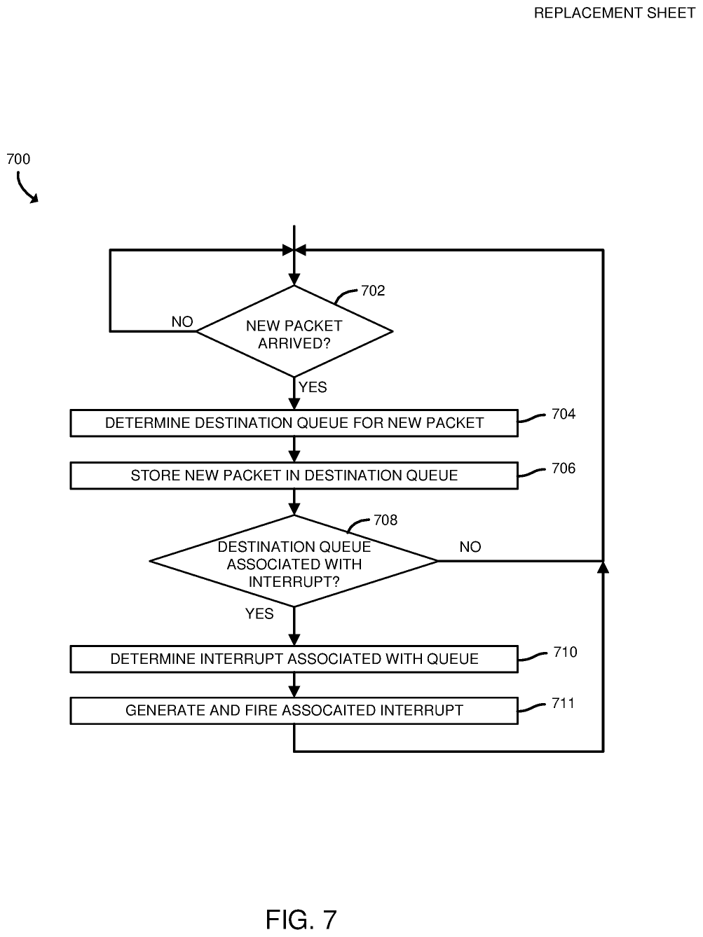

In block 520 of FIG. 6, the compute node 102 determines whether an interrupt has been received (e.g., an interrupt that was generated by the NIC 212 as described below in regard to FIG. 7). If so, the method 500 advances to block 522 in which the compute node 102 identifies and wakes up a sleeping application thread from the list of wakeable threads. To do so, in block 524, the compute node 102 identifies the sleeping application thread based on an associated application context and whether any queues have any events presently enqueued. Additionally, in block 526, the compute node 102 wakes up the sleeping thread using an interrupt service routine (ISR) call into a scheduler to the identified sleeping application thread of the interrupt disassociated queue. In block 528, the compute node 102 removes the thread identifier from the wakeup list. Subsequently, in block 530, the compute node 102 switches the thread from the interrupt event wait mode to the polling event wait mode, and the method 500 loops back to block 502 as discussed above.

Referring now to FIG. 7, in use, the NIC 212 of the compute node 102 may execute a method 700 for managing received data packets. The method 700 begins with block 720 in which the NIC 212 determines if a new data packet as arrived (e.g., from an external source device). If so, the method 704 advances to block 704 in which the NIC 212 determines a destination queue (e.g., one of the queues 205) for the new packet. For example, the NIC 212 may determine the destination queue based on the destination address of the new data packet and any available mapping data. In block 706, the NIC 212 stores the new data packet in the corresponding queue.

Subsequently, in block 708, the NIC 212 determines whether the destination queue is associate with an interrupt. For example, the compute node 102 may have associated the destination queue with an interrupt in the block 516 of method 500. If not, the method 700 loops back to block 702 in which the NIC 212 monitors for new packets. However, if the destination queue has been associated with an interrupt the method 700 advances to block 710. In block 710, the NIC 212 determines which interrupt is associated with the destination queue and generates and fires the determined queue in block 711. The method 700 subsequently loops back to block 702 in which the NIC 212 monitors for new packets. As discussed above in regard to block 520 and 522 of method 500, the fired interrupt causes the compute node 102 to identify and wakeup a sleeping thread associated with the destination queue.

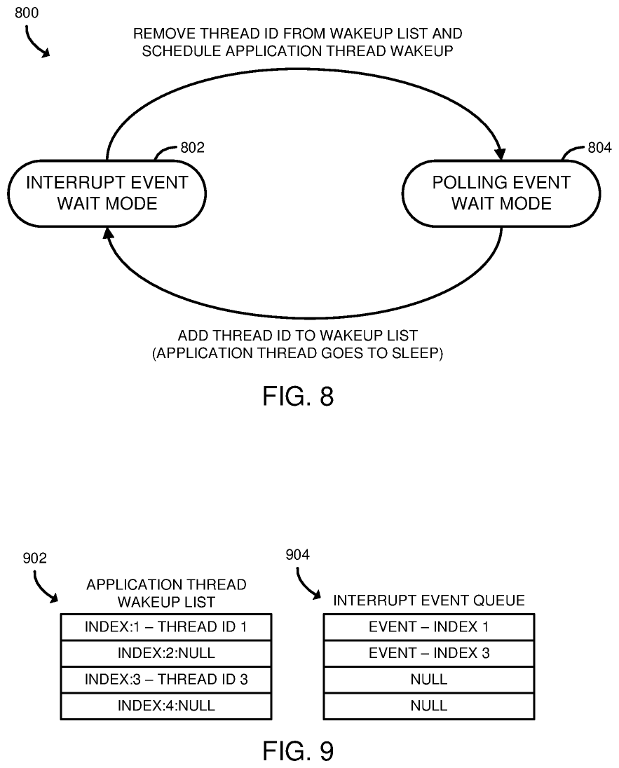

Referring now to FIG. 8, a simplified state flow diagram 800 is shown for illustrating state transitions for interrupt disassociated queues for multi-queue I/O devices of the compute node 102 as described herein. As described previously, an application thread can be in a polling event wait mode state and an interrupt event wait mode state, illustratively shown as interrupt event wait mode 802 and polling event wait mode 804 in FIG. 8. In polling event wait mode 804, the application thread is in the polling event wait mode state, and the interrupt disassociated queue is polled by the application thread. In interrupt event wait mode 802, the application thread is in the interrupt event wait mode state. In other words, polling by the application thread has stopped, an interrupt has been associated with the interrupt disassociated queue, and the interrupt disassociated queue is in interrupt event wait mode. As such, any new activity on the interrupt disassociated queue causes an interrupt to be generated.

As described previously, transitioning into interrupt event wait mode generally requires the interrupt disassociated queue to be associated with an interrupt. It should be appreciated that it may be possible for many quiesced interrupt disassociated queues to share an interrupt, depending on the embodiment. Accordingly, under such conditions that a previously allocated context that has an interrupt source is picked, and the interrupt is set to trigger for any new activity on this interrupt disassociated queue, support should to be provided/enabled in the I/O device (e.g., the NIC 212 of FIG. 2). It should be further appreciate that the context also contains the list of wakeable threads associated with this interrupt. As such, an employed solution would choose to have far fewer contexts with an interrupt source (e.g., in interrupt event wait mode) than those with an application source (e.g., in polling event wait mode). Further, when an interrupt occurs, the list of wakeable threads is checked to see if any of them are asleep, and, also, if their associated contexts, and queues, have any events. If so, as described previously, the application thread is scheduled for a wakeup and the application thread identifier is removed from the application thread wakeup list (see, e.g., the application thread wakeup list 902 of FIG. 9).

Alternatively, and generally more optimally, the cause for the interrupt is communicated to host software explicitly (e.g. the interrupt is due to activity on an interrupt disassociated queue). When an interrupt fires, the associated interrupt service routines call into the scheduler to wakeup the sleeping application thread associated with the applicable interrupt disassociated queue. Accordingly, when the application thread wakes up, the application thread triggers the polling loop. A separate event queue (see, e.g., the interrupt event queue 904 of FIG. 9) that only indicates activity on a given interrupt disassociated queue is one way to accomplish this.

Referring now to FIG. 9, an illustrative application thread wakeup list 902 and an interrupt event queue 904 are shown. In an illustrative embodiment in which there are four application threads, each with unique thread identifier 1-4 and each operating on an independent hardware queue mapped at queue index 1-4. Additionally, in an illustrative embodiment, the application threads with ID 1 and ID 3 go to sleep. Prior to going to sleep, each application thread adds itself to the application thread wakeup list 902 and then ties an interrupt to their respective interrupt disassociated queues (e.g., the interrupt disassociated queues at queue index 1 and 3). Accordingly, when the NIC 212 receives an incoming network packet destined for either of those interrupt disassociated queues, the network packet is stored in the corresponding queue and the NIC 212 generates an associated interrupt.

When the host software wakes up, the host software checks the event queue 904 and determines that there are two event causes. The host software then parses the event causes, retrieves the index, and wakes up the application thread at that index in the application thread wakeup list 902 (e.g., the application threads associated with index 1 and index 3). Prior to waking up the thread, the host software removes its identifier from the application thread wakeup list 902. It should be appreciated that, in some embodiments, an interrupt enabled context could also support an interrupt-disassociated context by toggling between the two modes as described herein.

### EXAMPLES

Illustrative examples of the technologies disclosed herein are provided below. An embodiment of the technologies may include any one or more, and any combination of, the examples described below.

Example 1 includes a compute node for interrupt disassociated queuing for multi-queue input/output (I/O) devices, the compute node comprising an I/O device; and circuitry to determine whether a network packet has arrived in an interrupt-disassociated queue; deliver, in response to a determination that the network packet has arrived in the interrupt-disassociated queue via the I/O device, the network packet to an application managed by the compute node, wherein the application is associated with an application thread, and wherein the interrupt-disassociated queue is in a polling mode; and transition, in response to a transition event, the interrupt-disassociated queue into an interrupt mode.

Example 2 includes the subject matter of Example 1, and wherein the circuitry is further to add, prior to the transition of the interrupt-disassociated queue into the interrupt mode, an identifier of the application thread to a list of wakeable threads, wherein the list of wakeable threads includes a plurality of wakeable application threads; and associate the interrupt-disassociated queue with an interrupt.

Example 3 includes the subject matter of any of Examples 1 and 2, and wherein the circuitry is further to detect a new activity on the interrupt-disassociated queue; and trigger the interrupt in response to any new activity detected on the interrupt-disassociated queue.

Example 4 includes the subject matter of any of Examples 1-3, and wherein to trigger the interrupt comprises to determine whether any of the wakeable application threads in the list of wakeable threads are asleep and an associated context has one or more events; schedule, in response to a determination that a wakeable application thread asleep in the list of wakeable threads is asleep and the associated context has the one or more events, the wakeable application thread for a wakeup; and remove an identifier of the wakeable application thread from the list of wakeable threads.

Example 5 includes the subject matter of any of Examples 1-4, and wherein to trigger the interrupt comprises to call an interrupt service routine into a scheduler of the compute node to wakeup a wakeable application thread associated with the interrupt-disassociated queue; trigger, subsequent to the wakeable application thread having woken up, a polling loop; and remove an identifier of the wakeable application thread from the list of wakeable threads.

Example 6 includes the subject matter of any of Examples 1-5, and wherein the interrupt-disassociated queue is associated with one or more interrupts.

Example 7 includes the subject matter of any of Examples 1-6, and wherein the transition event corresponds to an elapsed period of time. 8. The compute node of claim 1, wherein to determine whether a network packet has arrived in the interrupt-disassociated queue comprises to poll the interrupt-disassociated queue.

Example 9 includes a method for interrupt disassociated queuing, the method comprising determining, by a compute node, whether a network packet has arrived in an interrupt-disassociated queue; delivering, by the compute node and in response to a determination that the network packet has arrived in the interrupt-disassociated queue via an I/O device of the compute node, the network packet to an application managed by the compute node, wherein the application is associated with an application thread, and wherein the interrupt-disassociated queue is in a polling mode; and transition, in response to a transition event, the interrupt-disassociated queue into an interrupt mode.

Example 10 includes the subject matter of Example 9, and further including adding, by the compute node and prior to the transition of the interrupt-disassociated queue into the interrupt mode, an identifier of the application thread to a list of wakeable threads, wherein the list of wakeable threads includes a plurality of wakeable application threads; and associating, by the compute node, the interrupt-disassociated queue with an interrupt.

Example 11 includes the subject matter of any of Examples 9 and 10, and further including detecting, by the compute node, a new activity on the interrupt-disassociated queue; and triggering, by a network interface controller (NIC) of the compute node, the interrupt in response to any new activity detected on the interrupt-disassociated queue.

Example 12 includes the subject matter of any of Examples 9-11, and wherein triggering the interrupt comprises determining whether any of the wakeable application threads in the list of wakeable threads are asleep and an associated context has one or more events; scheduling, in response to a determination that a wakeable application thread asleep in the list of wakeable threads is asleep and the associated context has the one or more events, the wakeable application thread for a wakeup; and removing an identifier of the wakeable application thread from the list of wakeable threads.

Example 13 includes the subject matter of any of Examples 9-12, and wherein triggering the interrupt comprises calling an interrupt service routine into a scheduler of the compute node to wakeup a wakeable application thread associated with the interrupt-disassociated queue; triggering, subsequent to the wakeable application thread having woken up, a polling loop; and removing an identifier of the wakeable application thread from the list of wakeable threads.

Example 14 includes the subject matter of any of Examples 9-13, and wherein the interrupt-disassociated queue is associated with one or more interrupts.

Example 15 includes the subject matter of any of Examples 9-14, and wherein the transition event corresponds to an elapsed period of time. 16. The method of claim 9, wherein determining whether a network packet has arrived in the interrupt-disassociated queue comprises polling the interrupt-disassociated queue.

Example 17 includes one or more machine-readable storage media comprising a plurality of instructions stored thereon that, when executed, cause a compute node to determine whether a network packet has arrived in an interrupt-disassociated queue; deliver, in response to a determination that the network packet has arrived in the interrupt-disassociated queue via an I/O device of the compute node, the network packet to an application managed by the compute node, wherein the application is associated with an application thread, and wherein the interrupt-disassociated queue is in a polling mode; and transition, in response to a transition event, the interrupt-disassociated queue into an interrupt mode.

Example 18 includes the subject matter of Example 17, and wherein the plurality of instructions, when executed, further cause the compute node to add, prior to the transition of the interrupt-disassociated queue into the interrupt mode, an identifier of the application thread to a list of wakeable threads, wherein the list of wakeable threads includes a plurality of wakeable application threads; and associate the interrupt-disassociated queue with an interrupt.

Example 19 includes the subject matter of any of Examples 17 and 18, and wherein the plurality of instructions, when executed, further cause the compute node to detect a new activity on the interrupt-disassociated queue; and trigger the interrupt in response to any new activity detected on the interrupt-disassociated queue.

Example 20 includes the subject matter of any of Examples 17-19, and wherein to trigger the interrupt comprises to determine whether any of the wakeable application threads in the list of wakeable threads are asleep and an associated context has one or more events; schedule, in response to a determination that a wakeable application thread asleep in the list of wakeable threads is asleep and the associated context has the one or more events, the wakeable application thread for a wakeup; and remove an identifier of the wakeable application thread from the list of wakeable threads.

Example 21 includes the subject matter of any of Examples 17-20, and wherein to trigger the interrupt comprises to call an interrupt service routine into a scheduler of the compute node to wakeup a wakeable application thread associated with the interrupt-disassociated queue; trigger, subsequent to the wakeable application thread having woken up, a polling loop; and remove an identifier of the wakeable application thread from the list of wakeable threads.

Example 22 includes the subject matter of any of Examples 17-21, and wherein the interrupt-disassociated queue is associated with one or more interrupts.

Example 23 includes the subject matter of any of Examples 17-22, and wherein the transition event corresponds to an elapsed period of time. 24. The one or more machine-readable storage media of claim 17, wherein to determine whether a network packet has arrived in the interrupt-disassociated queue comprises to poll the interrupt-disassociated queue.

1. A compute node for interrupt disassociated queuing for multi-queue input/output (I/O) devices, the compute node comprising:
an I/O device; and
circuitry to:
determine whether a network packet has arrived in an interrupt-disassociated queue;
deliver, in response to a determination that the network packet has arrived in the interrupt-disassociated queue via the I/O device, the network packet to an application managed by the compute node, wherein the application is associated with an application thread, and wherein the interrupt-disassociated queue is in a polling mode; and
transition, in response to a transition event, the interrupt-disassociated queue into an interrupt mode.

2. The compute node of claim 1, wherein the circuitry is further to:
add, prior to the transition of the interrupt-disassociated queue into the interrupt mode, an identifier of the application thread to a list of wakeable threads, wherein the list of wakeable threads includes a plurality of wakeable application threads; and
associate the interrupt-disassociated queue with an interrupt.

3. The compute node of claim 2, wherein the circuitry is further to:
detect a new activity on the interrupt-disassociated queue; and
trigger the interrupt in response to any new activity detected on the interrupt-disassociated queue.

4. The compute node of claim 3, wherein to trigger the interrupt comprises to:
determine whether any of the wakeable application threads in the list of wakeable threads are asleep and an associated context has one or more events;
schedule, in response to a determination that a wakeable application thread asleep in the list of wakeable threads is asleep and the associated context has the one or more events, the wakeable application thread for a wakeup; and
remove an identifier of the wakeable application thread from the list of wakeable threads.

5. The compute node of claim 3, wherein to trigger the interrupt comprises to:
call an interrupt service routine into a scheduler of the compute node to wakeup a wakeable application thread associated with the interrupt-disassociated queue;
trigger, subsequent to the wakeable application thread having woken up, a polling loop; and
remove an identifier of the wakeable application thread from the list of wakeable threads.

6. The compute node of claim 2, wherein the interrupt-disassociated queue is associated with one or more interrupts.

7. The compute node of claim 1, wherein the transition event corresponds to an elapsed period of time.

8. The compute node of claim 1, wherein to determine whether a network packet has arrived in the interrupt-disassociated queue comprises to poll the interrupt-disassociated queue.

9. A method for interrupt disassociated queuing, the method comprising:
determining, by a compute node, whether a network packet has arrived in an interrupt-disassociated queue;
delivering, by the compute node and in response to a determination that the network packet has arrived in the interrupt-disassociated queue via an I/O device of the compute node, the network packet to an application managed by the compute node, wherein the application is associated with an application thread, and wherein the interrupt-disassociated queue is in a polling mode; and
transition, in response to a transition event, the interrupt-disassociated queue into an interrupt mode.

10. The method of claim 9, further comprising
adding, by the compute node and prior to the transition of the interrupt-disassociated queue into the interrupt mode, an identifier of the application thread to a list of wakeable threads, wherein the list of wakeable threads includes a plurality of wakeable application threads; and
associating, by the compute node, the interrupt-disassociated queue with an interrupt.

11. The method of claim 10, further comprising:
detecting, by the compute node, a new activity on the interrupt-disassociated queue; and
triggering, by a network interface controller (NIC) of the compute node, the interrupt in response to any new activity detected on the interrupt-disassociated queue.

12. The method of claim 11, wherein triggering the interrupt comprises:
determining whether any of the wakeable application threads in the list of wakeable threads are asleep and an associated context has one or more events;
scheduling, in response to a determination that a wakeable application thread asleep in the list of wakeable threads is asleep and the associated context has the one or more events, the wakeable application thread for a wakeup; and
removing an identifier of the wakeable application thread from the list of wakeable threads.

13. The method of claim 11, wherein triggering the interrupt comprises:
calling an interrupt service routine into a scheduler of the compute node to wakeup a wakeable application thread associated with the interrupt-disassociated queue;
triggering, subsequent to the wakeable application thread having woken up, a polling loop; and
removing an identifier of the wakeable application thread from the list of wakeable threads.

14. The method of claim 10, wherein the interrupt-disassociated queue is associated with one or more interrupts.

15. The method of claim 9, wherein the transition event corresponds to an elapsed period of time.

16. The method of claim 9, wherein determining whether a network packet has arrived in the interrupt-disassociated queue comprises polling the interrupt-disassociated queue.

17. One or more machine-readable storage media comprising a plurality of instructions stored thereon that, when executed, cause a compute node to:
determine whether a network packet has arrived in an interrupt-disassociated queue;
deliver, in response to a determination that the network packet has arrived in the interrupt-disassociated queue via an I/O device of the compute node, the network packet to an application managed by the compute node, wherein the application is associated with an application thread, and wherein the interrupt-disassociated queue is in a polling mode; and
transition, in response to a transition event, the interrupt-disassociated queue into an interrupt mode.

18. The one or more machine-readable storage media of claim 17, wherein the plurality of instructions, when executed, further cause the compute node to:
add, prior to the transition of the interrupt-disassociated queue into the interrupt mode, an identifier of the application thread to a list of wakeable threads, wherein the list of wakeable threads includes a plurality of wakeable application threads; and
associate the interrupt-disassociated queue with an interrupt.

19. The one or more machine-readable storage media of claim 18, wherein the plurality of instructions, when executed, further cause the compute node to:
detect a new activity on the interrupt-disassociated queue; and
trigger the interrupt in response to any new activity detected on the interrupt-disassociated queue.

20. The one or more machine-readable storage media of claim 19, wherein to trigger the interrupt comprises to:
determine whether any of the wakeable application threads in the list of wakeable threads are asleep and an associated context has one or more events;
schedule, in response to a determination that a wakeable application thread asleep in the list of wakeable threads is asleep and the associated context has the one or more events, the wakeable application thread for a wakeup; and
remove an identifier of the wakeable application thread from the list of wakeable threads.

21. The one or more machine-readable storage media of claim 19, wherein to trigger the interrupt comprises to:
call an interrupt service routine into a scheduler of the compute node to wakeup a wakeable application thread associated with the interrupt-disassociated queue;
trigger, subsequent to the wakeable application thread having woken up, a polling loop; and
remove an identifier of the wakeable application thread from the list of wakeable threads.

22. The one or more machine-readable storage media of claim 18, wherein the interrupt-disassociated queue is associated with one or more interrupts.

23. The one or more machine-readable storage media of claim 17, wherein the transition event corresponds to an elapsed period of time.

24. The one or more machine-readable storage media of claim 17, wherein to determine whether a network packet has arrived in the interrupt-disassociated queue comprises to poll the interrupt-disassociated queue.
